(19) United States
(12) Patent Application Publication
(10) Pub. No.: US 2017/0208799 A1
(43) Pub. Date: Jul. 27, 2017

(54) SYNERGISTIC ANTIMICROBIAL COMPOSITION

(71) Applicants: Dow Global Technologies LLC, Midland, MI (US); Dow Chemical IMEA GmbH, Horgen (CH)

(72) Inventors: Emerentiana Sianawati, Collegeville, PA (US); Freddie L. Singleton, Collegeville, PA (US); Subhash Nair, Dubai (AE); Junyu Chen, Shanghai (CN)

(21) Appl. No.: 15/329,652

(22) PCT Filed: Jul. 23, 2015
(86) PCT No.: PCT/US15/41770

§ 371 Date: Jan. 27, 2017

Related U.S. Application Data
(60) Provisional application No. 62/030,842, filed on Jul. 30, 2014.

(51) Int. Cl. A01N 33/20; C02F 1/50; A01N 33/04

(52) U.S. Cl. CPC A01N 33/20; A01N 33/04; C02F 1/50

(57) ABSTRACT

A synergistic antimicrobial composition comprising:
(a) tris(hydroxymethyl)nitromethane and
(b) quaternary ammonium compound.

This invention relates to combinations of biocides, the combinations having greater activity than would be observed for the individual antimicrobial compounds.

Use of combinations of at least two antimicrobial compounds can broaden potential markets, reduce use concentrations and costs, and reduce waste. In some cases, commercial antimicrobial compounds cannot provide effective control of microorganisms, even at high use concentrations, due to weak activity against certain types of microorganisms, or relatively slow antimicrobial action, or instability under certain conditions such as high temperature and high pH. Combinations of different antimicrobial compounds are sometimes used to provide overall control of microorganisms or to provide the same level of microbial control at lower use rates in a particular end-use environment. For example, U.S. Pat. No. 5,385,896 discloses combinations of phosphonium salts and aldehydes, but this reference does not suggest any of the combinations claimed herein. Moreover, there is a need for additional combinations of antimicrobial compounds having enhanced activity to provide effective control of microorganisms. The problem addressed by this invention is to provide such combinations of antimicrobial compounds.

### STATEMENT OF THE INVENTION

The present invention is directed to a synergistic antimicrobial composition comprising: (a) tris(hydroxymethyl)nitromethane (THNM) and (b) a quaternary ammonium compound (QAC); and wherein a weight ratio of the tris(hydroxymethyl)nitromethane to quaternary ammonium compound is from 160:1 to 1:13.

### DETAILED DESCRIPTION OF THE INVENTION

As used herein, the following terms have the designated definitions, unless the context clearly indicates otherwise. The term “antimicrobial compound” refers to a compound capable of inhibiting the growth or propagation of microorganisms, and/or killing microorganisms; antimicrobial compounds include bactericides, bacteristats, fungicides, fungistats, algaecides and algistats, depending on the dose level applied, system conditions and the level of microbial control desired. The term “microorganism” includes, for example, fungi (such as yeast and mold), bacteria, archaea, and algae. The following abbreviations are used throughout the specification: ppm=parts per million by weight (weight/weight), mL=milliliter. Unless otherwise specified, temperatures are in degrees centigrade (° C.), and references to percentages are by weight (wt. %). Percentages of antimicrobial compounds in the composition of this invention are based on the total weight of active ingredients in the composition, i.e., the antimicrobial compounds themselves, exclusive of any amounts of solvents, carriers, dispersants, stabilizers or other materials which may be present.

As used herein, quaternary ammonium compounds (QAC) are positively charged polyatomic ions of the structure NR₄⁺ with R being hydrogen, alkyl, alkylether or aryl groups, or salts thereof. The R groups may also be connected. The quaternary ammonium compound is selected from the group consisting of N-alkyl (50% C14, 40% C12, 10% C16) dimethyl benzyl ammonium chloride (ADBAC), didecyl ammonium chloride (DDAC), benzalkonium chloride (benzyl-C8-18-alkyldimethyl, chlorides) (BKC), and polixetonium chloride (poly (oxyethylene (dimethyliminio) ethylene (dimethyliminio) ethylene dichloride)(POLYQUAT). More than one quaternary ammonium compound may be present, in which case the biocide ratio is calculated from the total content of such compounds.

In some embodiments of the invention, a weight ratio of the tris(hydroxymethyl)nitromethane (THNM) to quaternary ammonium compound is from 160:1 to 1:13, alternatively from 80:1 to 1:13, alternatively from 80:1 to 1:1.6, alternatively from 40:1 to 10:1, alternatively from 40:1 to 1:3.2, alternatively from 40:1 to 1:13, alternatively from 20:1 to 2.5:1, alternatively from 20:1 to 1:3.2, and alternatively from 20:1 to 1:1.6. In some embodiments of the invention, the composition is used to prevent microbial growth in a medium at higher temperatures and high sulfide levels, i.e., at least 32° C. and 2 ppm sulfide, alternatively at least 50° C. and 2 ppm sulfide conditions which typically are present in oil and gas wells and reservoirs. In these embodiments, the weight ratio of the tris(hydroxymethyl)nitromethane to quaternary ammonium compound is from 160:1 to 1:13; alternatively from 80:1 to 1:1.6; and alternatively from 40:1 to 1:13. In some embodiments of the invention, a higher temperature and high-sulfide medium is one having a temperature at least 32° C. and a sulfide level at least 4 ppm. In some embodiments, the temperature is at least 60° C., alternatively at least 65° C.; alternatively at least 70° C.; alternatively at least 75° C.; alternatively at least 80° C. In some embodiments, the medium contains at least 5 ppm sulfide, alternatively at least 6 ppm sulfide, alternatively at least 7 ppm sulfide, alternatively at least 8 ppm sulfide, alternatively at least 9 ppm sulfide, alternatively at least 10 ppm sulfide. In some embodiments of the invention, the medium to which the antimicrobial composition is added is anaerobic. In some embodiments of the invention, the anaerobic medium is in a high-temperature and high-sulfide environment. In some embodiments of the invention, the medium to which the antimicrobial composition is added contains sulfate-reducing bacteria. In some embodiments of the invention, the medium to which the antimicrobial composition is added contains acid-producing bacteria. In some embodiments of the invention, the high-temperature and high-sulfide environment contains sulfate-reducing bacteria. In some embodiments of the invention, the medium to which the antimicrobial composition is added is an aqueous medium, i.e., one comprising at least 60% water, alternatively at least 80% water. In some embodiments of the invention, the aqueous medium is a high-temperature and high-sulfide medium.

In some embodiments of the invention, the antimicrobial combination of this invention is useful for inhibiting microbial growth in different media. The term media is defined as matrices and/or habitats in which microorganisms survive and/or grow. Examples of suitable medium media include oil and gas field injection, produced fluids, fracturing fluids, hydro-testing fluids, work-over fluids, and functional fluids, oil and gas wells, oil and gas operation, separation, storage, and transportation systems, oil and gas pipelines, oil and gas vessels, and fuel. The combination is especially useful in media such as aqueous fluids added to or produced by oil and gas well. The composition also is useful for controlling microorganisms in other industrial water and water containing/contaminated media, such as cooling water, air washer, heat exchangers, boiler water, pulp and paper mill water, other industrial process water media such as: ballast water, wastewater, metalworking fluids, latex, paint, coatings, adhesives, inks, tape joint compounds, pigment, water-based slurries, personal care and household products such as detergent, filtration systems (including reverse osmosis and ultrafiltration systems), toilet bowel, textiles, leather and leather production system, or a system used therewith.

Typically, the amount of the biocide combinations of the present invention to control the growth of microorganisms is from 10 ppm to 5,000 ppm active ingredient. In some embodiments of the invention, the active ingredients of the composition are present in an amount of at least 20 ppm, alternatively at least 50 ppm, alternatively at least 100 ppm, alternatively at least 150 ppm, alternatively at least 200 ppm. In some embodiments, the active ingredients of the composition are present in an amount of no more than 2,000 ppm, alternatively no more than 1,000 ppm, alternatively no more than 500 ppm, alternatively no more than 400 ppm, alternatively no more than 300 ppm, alternatively no more than 250 ppm, alternatively no more than 200 ppm, alternatively no more than 100 ppm, alternatively no more than 50 ppm. Concentrations mentioned above are in a liquid composition containing the biocide combinations. Biocide concentrations in a high-sulfide and high-temperature environment typically will be higher than in other environments.

The present invention also encompasses a method for reducing, or inhibiting, or preventing microbial growth in the use areas described above, especially in oil or natural gas production operations, by incorporating the claimed biocide combination into the materials.

### EXAMPLES

The synergism of the biocides combination of the present invention was determined using the method described by Kull, F. C, et al. in Applied Microbiology 9:538-541 (1961).

The formula to calculate the synergistic index (SI) is

Qa/QA+Qb/QB=SI

### Where

QA=concentration of compound A in ppm, acting alone produced an end point
Qa=concentration of compound A in ppm, in the mixture, which produced an end point
QB=concentration of compound B in ppm, acting alone produced an end point
Qb=concentration of compound B in ppm, in the mixture, which produced an end point

In this study, biocide end point is defined as exhibiting at least 4-log bacterial reduction or maintaining a maximum 2 log bacterial count at the specified contact time. If end point could not be established, the highest concentration of biocide tested will be used as the end point for the calculation and the SI will be recorded in “less than or <” values.

Synergism within two biocides is demonstrated when the SI has a value less than 1. The mixtures showed an additive effect if SI is equal to 1 and antagonistic if SI is greater than 1.

### Experimental Method

The list of biocides evaluated in this invention can be found in Table 1.

TABLE 1
Various Quaternary Compounds Evaluated with Tris(hydroxymethyl)nitromethane

| Organic biocides | Abbreviation | CAS NO. | Product |
|---|---|---|---|
| The first biocide | | | |
| Tris(hydroxymethyl)nitromethane | THNM | 126-11-4 | AQUCAR TN 50 |
| The second biocide | | | |
| N-alkyl (50% C14, 40% C12, 10% C16) dimethylbenzyl | ADBAC | 68424-85-1 | Maquat MC1412 |
| ammonium Chloride | | | |
| N-alkyl (50% C14, 40% C12, 10% C16) dimethylbenzyl | ADBAC | 68424-85-1 | Barquat MB-80 |
| ammonium Chloride | | | |
| Didecyl ammonium chloride | DDAC | 7173-51-5 | Maquat 4450-E |
| Benzalkonium chloride (benzyl-C8-18-alkyldimethyl, | BKC | 63449-41-2 | Fluka |
| chlorides) | | | |
| Polixetonium chloride (Poly (oxyethylene | Polyquat | 31512-74-0 | Polyquat 60 |
| (dimethyliminio) | | | |
| ethylene (dimethyliminio) ethylene | | | |
| dichloride) | | | |

### Experiment

The type of microorganisms used for the test inoculums, the matrix to support optimum microbial growth during the test period and the medium used to enumerate the microorganisms after specified contact time are summarized in Table 2.

The terms (MSM, SNF, and MB) as used in Table 2 are defined as follows:

Mineral salts medium (MSM). The medium contains (in mg/l) the following components: FeCl₃.6H₂O (1); CaCl₂.2H₂O (10); MgSO₄.7H₂O (22.5); (NH₄)₂SO₄ (40); KH₂PO₄ (10); K₂HPO₄ (25.5); Yeast Extract (10); and glucose (100). After all components are added to deionized water, the pH of the medium is adjusted to 7.5 before use.

Mineral salts medium (MSM No Nutrients). The medium contains (in mg/l) the following components: FeCl₃.6H₂O (1); CaCl₂.2H₂O (10); MgSO₄.7H₂O (22.5); (NH₄)₂SO₄ (40); KH₂PO₄ (10); and K₂HPO₄ (25.5). After all components are added to deionized water, the pH of the medium is adjusted to 7.5 before use.

SNF (per liter of deionized water): NaCl, 3.12 gm; NaHCO₃ 0.131 gm; Na₂SO₄ 0.17 gm; 1% KCl Solution (in water) 4.77 g; 1% CaCl₂ Solution (in water) 7.2 gm; 1% MgSO₄ Solution (in water) 5.45 gm; 1% Na₂CO₃ Solution (in water) 4.39 gm. Adjust the pH to 7 before use.

Modified Baar's medium (MB): MgSO₄, 2 g/l; sodium citrate, 5 g/l; CaSO₄, 1 g/l; NH₄Cl, g/l; K₂HPO₄, 0.5 g/l; sodium lactate, 3.5 g/l; yeast extract, 1 g/l; Sodium thioglycolate 0. g/l. Fe(NH₄)₂(SO₄)₂ 1 g/l, deionized water. Adjust the pH to 7.5 before sodium thioglycolate is added.

| Bacteria | Total microbial count (cfu/ml) | Matrix | Enumeration media |
|---|---|---|---|
| Aerobic bacteria | | | |
| Klebsiella pneumoniae (K. pneumoniae) | ~4.0 × 10⁶ | Minimal salt media | Tryptic soy broth + |
| (ATCC 8308) | | (MSM) - full nutrient | resazurin |
| Bacillus subtilis (B. subtilius) | | | |
| (ATCC 8473) | | | |
| Pseudomonas aeruginosa (P. aeruginosa) | | | |
| (ATCC 15442) | | | |
| Staphylococcus aureus (S. aureus) | | | |
| (ATCC 6538) | | | |
| Anaerobic | | | |
| Field isolate, Acid Producing | ~1.0 × 10⁷ | MSM (no nutrient) | Phenol Red Dextrose (PRD) |
| bacteria (APB) | | | |
| Desulfuvibrio longus (D. longus) | ~1.0 × 10⁷ | SNF | MB with 0.1% ferrous |
| S(RB) | | | ammonium sulfate |
| | | | hexahydrate |

Synergy tests of THNM alone and in combination with a second biocide against the different test microorganisms were conducted using standard 96 well microtiter plate assays. The test was carried out by adding 500 uL of matrix, 50 μl of tested organism and 50 μl of each biocide into wells of the microtiter plate. The final biocides and test inoculum concentrations in each well were established based on this total volume. For each experiment, the final concentration of the test organisms was in the range of 10⁶ to 10⁷ cfu/ml. The highest concentration of THNM and second biocide used in this synergy study was 250 and 100 or 50 ppm (depending on the efficacy of the active), respectively. Eight 2-fold dilutions of each biocide were prepared using an automated liquid handling system. The first biocide was added into the well plate horizontally and the second biocide is added after rotating the plate 90 degrees. Columns nine and ten were reserved for each individual biocide to be tested at each concentration level to achieve at least 4-log bacterial kill or 2-log bacterial count (defined as end point) for synergy index calculation. In case the end point was not achieved, the highest biocide concentration tested was used for synergy index calculation. Wells in Column 11 were used as positive controls; they contained only the media and the test organism. The plates were incubated at 25° C. for aerobic bacteria and 32° C. for anaerobic bacteria. Enumeration was performed 24 hours contact time by employing the MPN method. Numbers of surviving bacteria were determined by removing 20 uL of the cell suspension from each well and adding it into 180 ul of enumeration media (i.e., resazurin TSB plates) then serially dilute in a 96-well block. Plates were incubated for 48 hours or until growth is observed in the control wells.

The results of two biocides exhibiting synergy against aerobic bacteria are presented in Tables 3-6.

TABLE 3
Synergistic composition of THNM and ADBAC against aerobic bacteria

| | | | Maquat | | |
|---|---|---|---|---|---|
| Aqucar TN-50 | Maquat MC1412 | Aqucar TN-50 | MC1412 | | |
| (ppm THNM) - | (ppm ADBAC) - | (ppm THNM) - | (ppm ADBAC) - | | Ratio |
| Qa | Qb | QA | QB | SI = Qa/QA + Qb/QB | (THNM:ADBAC) |
| | | >250 | >50 | | |
| 125.00 | 25.00 | | | <1 | 20:1 |
| 62.50 | 25.00 | | | <0.75 | 10:1 |
| 31.25 | 25.00 | | | <0.63 | 5:1 |
| 15.63 | 25.00 | | | <0.56 | 2.5:1 |

Synergistic ratio: THNM:ADBAC: 20:1 to 2.5:1

TABLE 4
Synergistic composition of THNM and BKC against Aerobic bacteria

| | | | Benzalkonium | | |
|---|---|---|---|---|---|
| Aqucar TN-50 | BKC | Aqucar TN-50 | Chloride | | |
| (ppm THNM) - | (ppm ADBAC) - | (ppm THNM) - | (ppm BKC) - | | Ratio |
| Qa | Qb | QA | QB | SI = Qa/QA + Qb/QB | (THNM:ADBAC) |
| | | >250 | >50 | | |
| 125.00 | 25.00 | | | <1 | 5:1 |
| 62.50 | 25.00 | | | <0.75 | 2.5:1 |
| 31.25 | 25.00 | | | <0.63 | 1.25:1 |
| 15.63 | 25.00 | | | <0.56 | 1:1.6 |
| 7.81 | 25.00 | | | <0.53 | 1:3.2 |
| 3.91 | 25.00 | | | <0.52 | 1:6.41 |
| 1.95 | 25.00 | | | <0.51 | 1:12.8 |
| 125.00 | 12.50 | | | <0.75 | 10:1 |
| 62.50 | 12.50 | | | <0.50 | 5:1 |
| 31.25 | 12.50 | | | <0.38 | 2.5:1 |
| 15.63 | 12.50 | | | <0.31 | 1.25:1 |
| 7.81 | 12.50 | | | <0.28 | 1:1.6 |
| 3.91 | 12.50 | | | <0.27 | 1:3.2 |
| 1.95 | 12.50 | | | <0.26 | 1:6.41 |

Synergistic ratio THNM:BKC: 10:1 to 1:13

TABLE 5
Synergistic composition of THNM and DDAC against Aerobic bacteria

| Aqucar TN-50 | Maquat 4450-E | Aqucar TN-50 | Maquat 4450-E | | |
|---|---|---|---|---|---|
| (ppm THNM) - | (ppm DDAC) - | (ppm THNM) - | (ppm DDAC) - | | Ratio |
| Qa | Qb | QA | QB | SI = Qa/QA + Qb/QB | (THNM:ADBAC) |
| | | >250 | >50 | | |
| 125.00 | 25.00 | | | <1 | 5:1 |
| 62.50 | 25.00 | | | <0.75 | 2.5:1 |
| 31.25 | 25.00 | | | <0.63 | 1.25:1 |
| 15.63 | 25.00 | | | <0.56 | 1:1.6 |
| 7.81 | 25.00 | | | <0.53 | 1:3.2 |
| 3.91 | 25.00 | | | <0.52 | 1:6.41 |
| 1.95 | 25.00 | | | <0.51 | 1:12.80 |
| 125.00 | 12.50 | | | <0.75 | 10:1 |
| 62.50 | 12.50 | | | <0.50 | 5:1 |
| 31.25 | 12.50 | | | <0.38 | 2.5:1 |
| 15.63 | 12.50 | | | <0.31 | 1.25:1 |
| 7.81 | 12.50 | | | <0.28 | 1:1.6 |
| 3.91 | 12.50 | | | <0.27 | 1:3.2 |
| 1.95 | 12.50 | | | <0.26 | 1:6.41 |

### Synergistic Ratio THNM:DDAC: 10:1 to 1:13

TABLE 6
Synergistic composition of THNM and Polyixetonium chloride against D. longus

| | Polyquat 60 | Aqucar TN- | Polyquat 60 | | |
|---|---|---|---|---|---|
| Aqucar TN-50 | (ppm | 50 | (ppm | | |
| (ppm THNM) - | Polyixetonium | (ppm | Polyixetonium | SI = Qa/QA + | Ratio |
| Qa | chloride) - Qb | THNM) - QA | chloride) - QB | Qb/QB | (THNM:ADBAC) |
| | | >250 | >50 | | |
| 125.00 | 25.00 | | | <1 | 5:1 |
| 62.50 | 25.00 | | | <0.75 | 2.5:1 |
| 31.25 | 25.00 | | | <0.63 | 1.25:1 |
| 15.63 | 25.00 | | | <0.56 | 1:1.6 |
| 7.81 | 25.00 | | | <0.53 | 1:3.2 |
| 3.91 | 25.00 | | | <0.52 | 1:6.41 |
| 1.95 | 25.00 | | | <0.51 | 1:12.80 |
| 125.00 | 12.50 | | | <0.75 | 10:1 |
| 62.50 | 12.50 | | | <0.50 | 5:1 |
| 31.25 | 12.50 | | | <0.38 | 2.5:1 |
| 15.63 | 12.50 | | | <0.31 | 1.25:1 |
| 7.81 | 12.50 | | | <0.28 | 1:1.6 |
| 3.91 | 12.50 | | | <0.27 | 1:3.2 |
| 1.95 | 12.50 | | | <0.26 | 1:6.41 |
| 125.00 | 6.25 | | | <0.63 | 20:1 |
| 62.50 | 6.25 | | | <0.38 | 10:1 |
| 31.25 | 6.25 | | | <0.25 | 5:1 |
| 15.63 | 6.25 | | | <0.19 | 2.5:1 |
| 7.81 | 6.25 | | | <0.16 | 1.25:1 |
| 3.91 | 6.25 | | | <0.14 | 1:1.6 |
| 1.95 | 6.25 | | | <0.13 | 1:3.2 |
| 125.00 | 3.13 | | | <0.56 | 40:1 |
| 62.50 | 3.13 | | | <0.31 | 20:1 |
| 31.25 | 3.13 | | | <0.19 | 10:1 |
| 15.63 | 3.13 | | | <0.13 | 5:1 |
| 7.81 | 3.13 | | | <0.09 | 2.5:1 |
| 3.91 | 3.13 | | | <0.08 | 1.25:1 |
| 1.95 | 3.13 | | | <0.07 | 1:1.6 |

Synergistic ratio THNM:polyquat: 40:1 to 1:13

The results of two biocides exhibiting synergy against anaerobic sulfate reducing bacteria are presented in Tables 7-10

TABLE 7
Synergistic composition of THNM and ADBAC against D. longus

| Aqucar TN-50 | Maquat MC1412 | Aqucar TN-50 | Maquat MC1412 | | |
|---|---|---|---|---|---|
| (ppm THNM) - | (ppm ADBAC) - | (ppm THNM) - | (ppm ADBAC) - | | Ratio |
| Qa | Qb | QA | QB | SI = Qa/QA + Qb/QB | (THNM:ADBAC) |
| | | 250.00 | 6.25 | | |
| 62.50 | 3.13 | | | 0.75 | 20:1 |
| 31.25 | 3.13 | | | 0.63 | 10:1 |
| 15.63 | 3.13 | | | 0.56 | 5:1 |
| 7.81 | 3.13 | | | 0.53 | 2.5:1 |
| 3.91 | 3.13 | | | 0.52 | 1.25:1 |
| 1.95 | 3.13 | | | 0.51 | 1:1.6 |
| 125.00 | 1.56 | | | 0.75 | 80:1 |
| 62.50 | 1.56 | | | 0.50 | 40:1 |

Synergistic ratio THNM:ADBAC: 80:1 to 1:1.6

TABLE 8
Synergistic composition of THNM and BKC against D. longus

| Aqucar TN-50 | BKC | Aqucar TN-50 | BKC | | |
|---|---|---|---|---|---|
| (ppm THNM) - | (ppm ADBAC) - | (ppm THNM) - | (ppm ADBAC) - | SI = Qa/QA + | Ratio |
| Qa | Qb | QA | QB | Qb/QB | (THNM:ADBAC) |
| | | 250.00 | 3.13 | | |
| 62.50 | 1.56 | | | 0.75 | 40:1 |
| 31.25 | 1.56 | | | 0.63 | 20:1 |
| 15.63 | 1.56 | | | 0.56 | 10:1 |
| 7.81 | 1.56 | | | 0.53 | 5:1 |
| 3.91 | 1.56 | | | 0.52 | 2.5:1 |
| 1.95 | 1.56 | | | 0.51 | 1.25:1 |
| 125.00 | 0.78 | | | 0.75 | 160:1 |

Synergistic ratio of THNM:BKC: 160:1 to 1.25:1

TABLE 9
Synergistic composition of THNM and DDAC against D. longus

| Aqucar TN-50 | | Aqucar TN-50 | | | |
|---|---|---|---|---|---|
| (ppm THNM) - | Maquat 4450-E | (ppm THNM) - | Maquat 4450-E | SI = Qa/QA + | Ratio |
| Qa | (ppm DDAC) - Qb | QA | (ppm DDAC) - QB | Qb/QB | (THNM:ADBAC) |
| | | 250.00 | 6.25 | | |
| 62.50 | 3.13 | | | 0.75 | 20:1 |
| 31.25 | 3.13 | | | 0.63 | 10:1 |
| 15.63 | 3.13 | | | 0.56 | 5:1 |
| 7.81 | 3.13 | | | 0.53 | 2.5:1 |
| 3.91 | 3.13 | | | 0.52 | 1.25:1 |
| 1.95 | 3.13 | | | 0.51 | 1:1.6 |
| 125.00 | 1.56 | | | 0.75 | 80:1 |
| 62.50 | 1.56 | | | 0.50 | 40:1 |

Synergistic ratio of THNM:DDAC: 80:1 to 1:1.6

TABLE 10
Synergistic composition of THNM and Polyixetonium chloride against D. longus

| | Polyquat 60 | | Polyquat 60 | | |
|---|---|---|---|---|---|
| Aqucar TN-50 | (ppm | Aqucar TN-50 | (ppm | | |
| (ppm THNM) - | Polyixetonium | (ppm THNM) - | Polyixetonium | SI = Qa/QA + | Ratio |
| Qa | chloride) - Qb | QA | chloride) - QB | Qb/QB | (THNM:ADBAC) |
| | | 250.00 | 6.25 | | |
| 62.50 | 3.13 | | | 0.75 | 20:1 |
| 31.25 | 3.13 | | | 0.63 | 10:1 |
| 15.63 | 3.13 | | | 0.56 | 5:1 |
| 7.81 | 3.13 | | | 0.53 | 2.5:1 |
| 3.91 | 3.13 | | | 0.52 | 1.25:1 |
| 1.95 | 3.13 | | | 0.51 | 1:1.6 |
| 125.00 | 1.56 | | | 0.75 | 80:1 |
| 62.50 | 1.56 | | | 0.50 | 40:1 |

Synergistic ratio of THNM:Polyquat: 80:1 to 1:1.6

The results of two biocides exhibiting synergy against anaerobic acid producing bacteria are presented in Tables 11-14

TABLE 11
Synergistic composition of THNM and ADBAC against Environmental isolate APB

| | Maquat | | Maquat | | |
|---|---|---|---|---|---|
| Aqucar TN- | MC1412 | Aqucar TN- | MC1412 | | |
| 50 | (ppm | 50 | (ppm | | |
| (ppm | ADBAC) - | (ppm | ADBAC) - | | Ratio |
| THNM) - Qa | Qb | THNM) - QA | QB | SI = Qa/QA + Qb/QB | (THNM:ADBAC) |
| | | >250 | 12.5 | | |
| 125.00 | 6.25 | | | <1 | 20:1 |
| 62.50 | 6.25 | | | <0.75 | 10:1 |
| 31.25 | 6.25 | | | <0.63 | 5:1 |
| 15.63 | 6.25 | | | <0.56 | 2.5:1 |
| 7.81 | 6.25 | | | <0.53 | 1.25:1 |
| 3.91 | 6.25 | | | <0.52 | 1:1.6 |

Synergistic ratio of THNM:ADBAC is 20:1 to 1:1.6.

TABLE 12
Synergistic composition of THNM and BKC against Environmental isolate APB

| Aqucar TN- | BKC | Aqucar TN- | BKC | | |
|---|---|---|---|---|---|
| 50 | (ppm | 50 | (ppm | | |
| (ppm | ADBAC) - | (ppm | ADBAC) - | | Ratio |
| THNM) - Qa | Qb | THNM) - QA | QB | SI = Qa/QA + Qb/QB | (THNM:ADBAC) |
| | | >250 | 12.50 | | |
| 125.00 | 6.25 | | | <1 | 20:1 |
| 62.50 | 6.25 | | | <0.75 | 10:1 |
| 31.25 | 6.25 | | | <0.63 | 5:1 |
| 15.63 | 6.25 | | | <0.56 | 2.5:1 |
| 7.81 | 6.25 | | | <0.53 | 1.25:1 |
| 3.91 | 6.25 | | | <0.52 | 1:1.6 |
| 1.95 | 6.25 | | | <0.51 | 1:3.2 |

Synergistic ratio of THNM:BKC is 20:1 to 1:3.2.

TABLE 13
Synergistic composition of THNM and DDAC against Environmental isolate APB

| Aqucar TN- | | Aqucar TN- | Maquat | | |
|---|---|---|---|---|---|
| 50 | Maquat 4450-E | 50 | 4450-E | | |
| (ppm | (ppm DDAC) - | (ppm | (ppm DDAC) - | | Ratio |
| THNM) - Qa | Qb | THNM) - QA | QB | SI = Qa/QA + Qb/QB | (THNM:ADBAC) |
| | | >250 | 12.50 | | |
| 125.00 | 6.25 | | | <1 | 20:1 |
| 62.50 | 6.25 | | | <0.75 | 10:1 |
| 31.25 | 6.25 | | | <0.63 | 5:1 |
| 15.63 | 6.25 | | | <0.56 | 2.5:1 |
| 7.81 | 6.25 | | | <0.53 | 1.25:1 |
| 3.91 | 6.25 | | | <0.52 | 1:1.6 |
| 1.95 | 6.25 | | | <0.51 | 1:3.2 |
| 125.00 | 3.13 | | | <0.75 | 40:1 |
| 62.50 | 3.13 | | | <0.5 | 20:1 |
| 31.25 | 3.13 | | | <0.38 | 10:1 |
| 15.63 | 3.13 | | | <0.31 | 5:1 |
| 7.81 | 3.13 | | | <0.28 | 2.5:1 |
| 3.91 | 3.13 | | | <0.27 | 1.25:1 |
| 1.95 | 3.13 | | | <0.26 | 1:1.6 |

Synergistic ratio of THNM:DDAC is 40:1 to 1:3.2.

TABLE 14
Synergistic composition of THNM and Polyquat against Environmental isolate APB

| Aqucar TN- | | Aqucar TN- | | | |
|---|---|---|---|---|---|
| 50 | Polyquat 60 | 50 | Polyquat 60 | | |
| (ppm | (ppm | (ppm | (ppm | | |
| THNM) - | Polyixetonium | THNM) - | Polyixetonium | SI = Qa/QA + | Ratio |
| Qa | chloride) - Qb | QA | chloride) - QB | Qb/QB | (THNM:ADBAC) |
| | | >250 | >50 | | |
| 250.00 | 50.00 | | | <2 | 20:1 |
| 125.00 | 50.00 | | | <1.5 | 10:1 |
| 250.00 | 12.50 | | | <1.25 | 40:1 |

Synergistic ratio of THNM:Polyquat is 40:1 to 10:1

1. An antimicrobial composition comprising: (a) tris(hydroxymethyl)nitromethane; and
(b) a quaternary ammonium compound; wherein a weight ratio of the tris(hydroxymethyl)nitromethane to quaternary ammonium compound is from 160:1 to 1:13.

2. The composition of claim 1 wherein the quaternary ammonium compound is N-alkyl (50% C14, 40% C12, 10% C16) dimethylbenzyl ammonium chloride present in a ratio from 80:1 to 1:1.6.

3. The composition of claim 1 wherein the quaternary ammonium compound is didecyl ammonium chloride present in a ratio from 80:1 to 1:13.

4. The composition of claim 1 wherein the quaternary ammonium compound is benzalkonium chloride present in a ratio from 160:1 to 1:13.

5. The composition of claim 1 wherein the quaternary ammonium compound is polixetonium chloride present in a ratio from 80:1 to 1:13.

6. A method for inhibiting microbial growth in a medium, the method comprising adding to a medium the composition of claim 1.

7. The method of claim 6 in which the medium is anaerobic.

8. The method of claim 7 in which the, medium contains sulfate-reducing microorganisms.

9. The method of claim 7 in which the medium contains acid-producing microorganisms.

10. The method of claim 6 in which the medium is aerobic.
